(19) United States
(12) Patent Application Publication
(10) Pub. No.: US 2016/0056558 A1
(43) Pub. Date: Feb. 25, 2016

(54) MICRO-ARRAY CONNECTOR STACK-UP

(71) Applicant: APPLE INC., Cupertino, CA (US)

(72) Inventors: Aaron N. Miletich, San Jose, CA (US); George T. Tziviskos, Cupertino, CA (US); George Marc Simmell, Cupertino, CA (US)

(73) Assignee: APPLE INC., Cupertino, CA (US)

(21) Appl. No.: 14/929,416

(22) Filed: Nov. 2, 2015

Related U.S. Application Data
(60) Provisional application No. 62/074,074, filed on Nov. 2, 2014.

(51) Int. Cl. H01R 12/70; H01R 43/20

(52) U.S. Cl. CPC H01R 12/7076; H01R 43/205

(57) ABSTRACT

Board-to-board connectors that are small in size and provide a low-profile.

### CROSS-REFERENCES TO RELATED APPLICATIONS

This application claims the benefit of U.S. provisional application No. 62/074,074, filed on Nov. 2, 2015, which is incorporated by reference.

### BACKGROUND

The number of types of electronic devices that are commercially available has increased tremendously the past few years and the rate of introduction of new devices shows no signs of abating. Devices, such as tablet, laptop, netbook, desktop, and all-in-one computers, cell, smart, and media phones, storage devices, portable media players, navigation systems, monitors, and others, have become ubiquitous.

The functionality of these devices has likewise greatly increased. This in turn has led to increased complexity inside of these electronic devices. For example, several types of boards, such as flexible circuit boards, printed circuit boards, and others, are often included in a single device. These boards may be connected together using board-to-board connectors.

Often these connectors may be large. That is, these connectors may consume a large area on a printed circuit board or other substrate. Also, they may be tall in a vertical direction above a board. Because of this, these connectors may consume board area and space inside an electronic device. This may result in either the device having less functionality, a larger size, or a combination of the two. Smaller connectors may save space, allowing more functionality in a device, they may allow a device to be smaller, or a combination of each.

Thus, what is needed are board-to-board connectors that may save board space and have a low profile.

### SUMMARY

Accordingly, embodiments of the present invention may provide board-to-board connectors that may save board space and have a low profile.

One illustrative embodiment of the present invention may provide a connector system including a connector plug and a connector receptacle. The connector plug may include a number of contacts to be soldered to or otherwise electrically connected to pads or contacts on a printed circuit or other board. The contacts may be supported by a plug substrate or stiffener layer. The contacts may extend beyond a top surface of the stiffener layer. An insulating layer over the substrate may be held in place by an adhesive layer. The insulating layer may be formed of polyimide or other material. The connector plug may have one or more openings through which a corresponding one or more fasteners may pass. The openings may be located near a center of the connector plug, near ends of the connector plug, or at other locations on the connector plug. An alignment ring may surround one or more of the openings on the connector plug. The alignment ring may be formed by plating or other process. The alignment ring may be formed at the same time as the plug contacts or it may be formed at a different time.

This connector system may further include a connector receptacle. The connector receptacle may include a substrate or stiffener layer having a number of passages, each to accept a plug contact. Receptacle contacts may be located at openings of the passages. These contacts may be metallic and may deflect as a plug contact is inserted such that the receptacle contacts and plug contacts form electrical connections. The receptacle contacts may electrically connect to contact portions, which may be soldered or otherwise attached to form electrical connections to pads or contacts on a flexible circuit board or other substrate. An insulating layer may be placed between the receptacle stiffener layer and the receptacle contacts. The insulating layer may be formed of polyimide or other material. An adhesive layer may be used to attach the insulating layer to the receptacle stiffener layer. Like the connector plug, the connector receptacle may include one or more openings through which a corresponding one or more fasteners may pass. The openings may be located near a center of the connector receptacle, near ends of the connector receptacle, or at other locations on the connector receptacle. The one or more openings in the receptacle may be arranged to accept the one or more alignment rings on the connector plug.

A stiffener layer may be formed or placed over one side of the flexible circuit board to provide mechanical reinforcement. The flex stiffener layer, the flexible circuit board, and the substrate may each have one or more openings through which a corresponding one or more fasteners may pass. The fasteners may include screws, nuts, bolts, collets, or other types of fasteners. The fasteners may have heads arranged to fit in recesses formed in either or both the flex stiffener and printed circuit board. The fasteners may have threaded bodies arranged to be threaded together to hold the connector plug to the connector receptacle.

Another illustrative embodiment of the present invention may provide a method of assembling a board-to-board connector. The method may include attaching a connector plug to a printed circuit board, the connector plug comprising a plurality of contacts fixed together by a plug stiffener layer, each electrically connected to a contact on a top surface of the printed circuit board and extending above the plug stiffener layer, the connector plug further comprising an opening, the opening surrounded by an alignment ring. The method may further include attaching a connector receptacle to a flexible circuit board, the connector receptacle comprising a plurality of contacts fixed together by a receptacle stiffener layer having a corresponding plurality of passages, each contact electrically connected to a contact on a bottom surface of the flexible circuit board, each receptacle contact at least partially covering a bottom of a passage. The connector plug and the connector receptacle may be mated such that the alignment ring on the connector plug fits in an opening in the connector receptacle and each of the connector plug contacts is inserted in a corresponding passage in the connector receptacle such that it is electrically connected to a receptacle contact. A first fastener may be fit to the printed circuit board and a second fastener may be inserted through an opening in the flexible circuit board, the opening in the connector receptacle, and the opening in the connector plug such that it engages the first fastener.

Fitting the first fastener to the printed circuit board may include placing a body of the fastener into an opening in the printed circuit board from a bottom of the printed circuit board such that a head of the printed circuit board fits in a recess in the bottom of the printed circuit board. Fitting the first fastener to the printed circuit board may instead include placing a body of the fastener into an opening in the printed circuit board from a top of the printed circuit board such that a head of the printed circuit board rests on a top of the printed circuit board.

Embodiments of the present invention are particularly well-suited to connecting flexible circuit boards to printed circuit boards, though embodiments of the present invention may be used to connect two or more boards together, where the two or more boards include flexible circuit boards, printed circuit boards, or other appropriate boards. For example, embodiments of the present invention may be used to connect two flexible circuit boards, two printed circuit boards, two flexible circuit boards and one printed circuit board, or other combination of boards.

An illustrative embodiment of the present invention may provide board-to-board connectors where contacts in a plug form electrical connections with traces or planes in or on a first or printed circuit board. Similarly, contacts in a receptacle may form electrical connections with traces or planes in or on a second or flexible circuit board. Contacts in the plug may mate with contacts in the receptacle. In this way, traces and planes on a first or printed circuit board may be electrically connected to traces and planes on a second or flexible circuit board. These various connections may convey power supplies, ground, data, and other types of voltages and signals.

In various embodiments of the present invention, plug and receptacle contacts may be formed by stamping, metal-injection molding, machining, micro-machining, 3-D printing, or other manufacturing process. The plug and receptacle contacts and other conductive portions may be formed of stainless steel, steel, copper, copper titanium, phosphor bronze, or other material or combination of materials. They may be plated or coated with nickel, gold, or other material. The flex, plug, and receptacle stiffeners may be formed of silicon or silicone, rubber, hard rubber, plastic, nylon, liquid-crystal polymers (LCPs), or other conductive or nonconductive material or combination of materials. One or more of the flex, plug, and receptacle stiffener layers may be formed of Basalt, S-2 glass (around 90 GPa), S-3 UHM glass (99 GPa), quartz or astroquartz, aramid (commercially sold as Kevlar 49 or Twaron, ceramic (3M Nextel 312, 440, 550, 610, 72, having tensile modulus 150, 190, 193, 380, 260, respectively, Zylon (180), Zylon HM (270), or PE (commercially sold as Spectra or Dyneema) stainless steel, or other material. In these and other embodiments of the present invention, one or more of the flex, plug, and receptacle stiffener layers may be formed of carbon fiber, a composite laminate structure, or other material or structure.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a board-to-board connector system according to an embodiment of the present invention;

FIG. 2 illustrates a connector plug according to an embodiment of the present invention;

FIG. 3 illustrates a side view of a portion of a connector plug according to an embodiment of the present invention;

FIG. 4 illustrates a connector receptacle according to an embodiment of the present invention;

FIG. 5 illustrates a side view of a portion of a board-to-board connector system according to an embodiment of the present invention;

FIG. 6 illustrates a side view of a board-to-board connector according to an embodiment of the present invention;

FIG. 7 illustrates a closer side view of a board-to-board connector system according to an embodiment of the present invention;

FIG. 8 illustrates portions of a board-to-board connector system according to an embodiment of the present invention;

FIG. 9 illustrates portions of a board-to-board connector system according to an embodiment of the present invention; and

FIG. 10 illustrates a portion of a connector receptacle according to an embodiment of the present invention.

### DESCRIPTION OF EXEMPLARY EMBODIMENTS

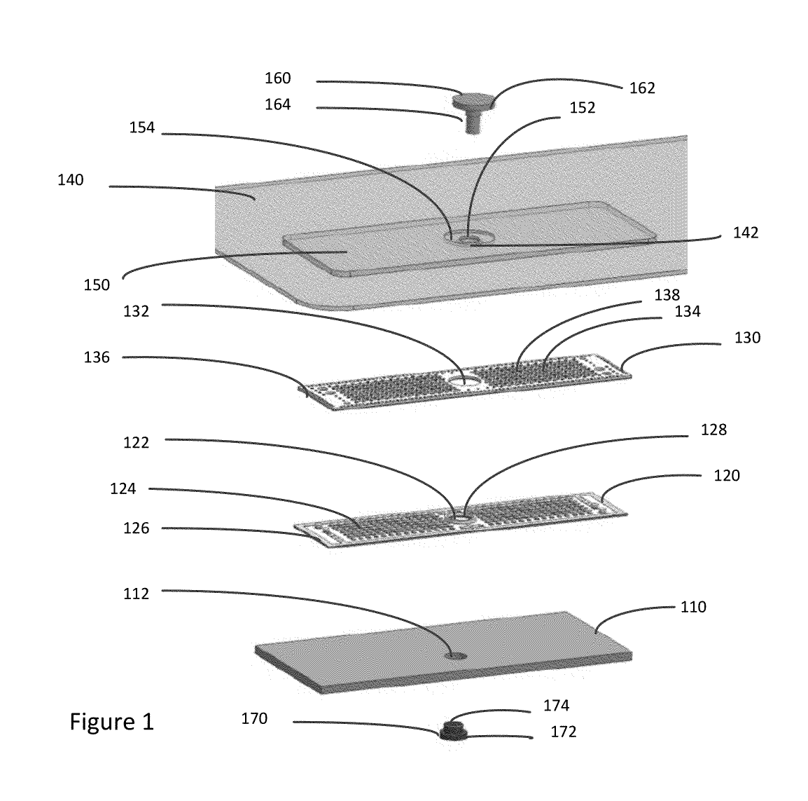

FIG. 1 illustrates a board-to-board connector system according to an embodiment of the present invention. This figure, as with the other figures, is included for illustrative purposes and does not limit either the possible embodiments of the present invention or the claims.

This connector system includes a printed circuit board or other substrate 110 having an opening 112. A number of contacts (not shown) may be located on a top surface of printed circuit board 110. These contacts may electrically connect to traces, circuits, and other electronic components on or in the printed circuit board 110.

Connector plug 120 may include a number of contacts 124, which may mate to with the contacts on the top surface of printed circuit board 110. Contacts 124 may be supported by plug stiffener 126. Connector plug 120 may also include an opening 122, which may be surrounded by alignment ring 128. Alignment ring 128 may be formed by plating or other process. For example, alignment ring 120 may be formed by plating along with contacts 124. In other embodiments of the present invention, alignment ring 128 may be formed separately from plug contacts 124.

Connector receptacle 130 may include a number of contacts 134. Contacts 134 may accept plug contacts 124 when receptacle 130 is mated with plug 120. Contact openings 134 may electrically connect to contact portions 138. Contact portions 138 may connect to contacts or pads on an underside of flexible circuit board 140, which in turn may connect to traces, circuit, and other electronic components on or in the flexible circuit board 140. Connector receptacle 130 may also include opening 132.

Flexible circuit board 140 may be a flexible circuit board or other appropriate substrate. Flexible circuit board 140 may include interconnect traces, as well as electrical components or circuits. Flexible circuit board 140 may also include opening 142.

A stiffener on flex layer 150 may be used to mechanically support flexible circuit board 140. Stiffener layer 150 may include an opening 152 as well as a recessed portion 150 to accept a head of a fastener.

A fastener may be used to secure these structures together. For example, a fastener, such as a screw 160, may be inserted into a nut or other fastener, such as nut 170, to secure this connector system together. Screw 160 may have a head 162 and a body portion 164. Body portion 164 may be threaded to mate with threads on the inside of a portion 174 of nut 170. Nut 170 may have a head 172. Head 172 may fit in a recessed portion of a bottom side of printed circuit board 110 such that a bottom surface of nut 170 is flush with the bottom surface of printed circuit board 110. The body 164 of fastener 160 may fit through openings 152 in flex stiffener 150, opening 142 in flexible circuit board 140, opening 132 in receptacle 130, opening 122 in plug 120, and opening 112 in printed circuit board 110. In this example, the fasteners screw 160 and 170 may be placed approximately in the center of the board-to-board connector system. In other embodiments of the present invention, more than one fastener, placed at other positions, such as near the ends of the connector, may be used.

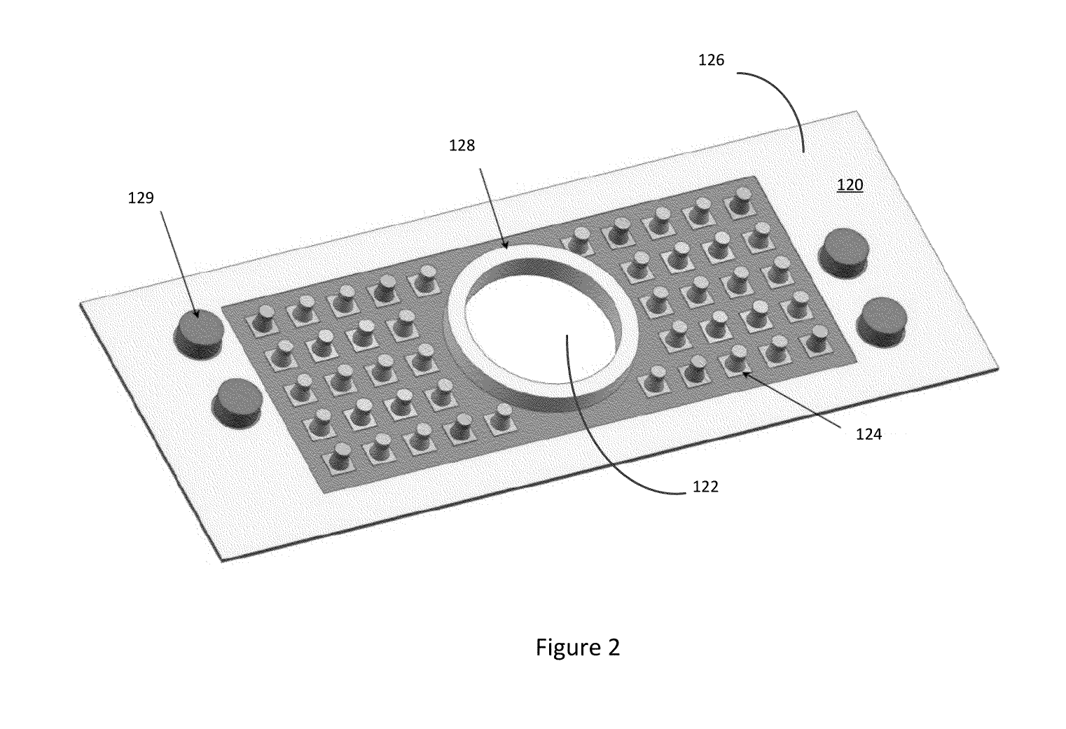

FIG. 2 illustrates a connector plug according to an embodiment of the present invention. This connector plug may be used as connector plug 120 in FIG. 1, or as a connector plug in other embodiments of the present invention. Connector plug 120 may include a number of contacts 124. Contacts 124 may extend above a top surface of the plug as shown and may be available at a bottom surface to mate with corresponding contacts on a printed circuit board or other appropriate substrate. Contacts 124 may have various sizes. For example, they may be 0.3, 0.25, or 0.2 millimeters or other size in diameter. In various embodiments of the present invention, this size may be adjusted to provide sufficient strength to withstand shear forces while also providing a space-saving sized connector. Connector plug 120 may also include opening 122. Opening 122 may be surrounded by alignment ring 128. Alignment ring 128 may be formed by plating along with plug contacts 124. In other embodiments of the present invention, alignment ring 128 may be formed separately from plug contacts 124. Plug 120 may also include larger contacts 129. These larger contacts may provide pathways for power or other high current connections. These larger power pins may be 0.6, 0.5, or 0.4 millimeters or other size in diameter. These larger contacts may reduce resistance and increase current carrying capabilities. Contacts 129 may further provide an alignment function for when connector receptacle 130 is mated to connector plug 120. Contacts 124 and 129 may be supported by plug stiffener layer 126.

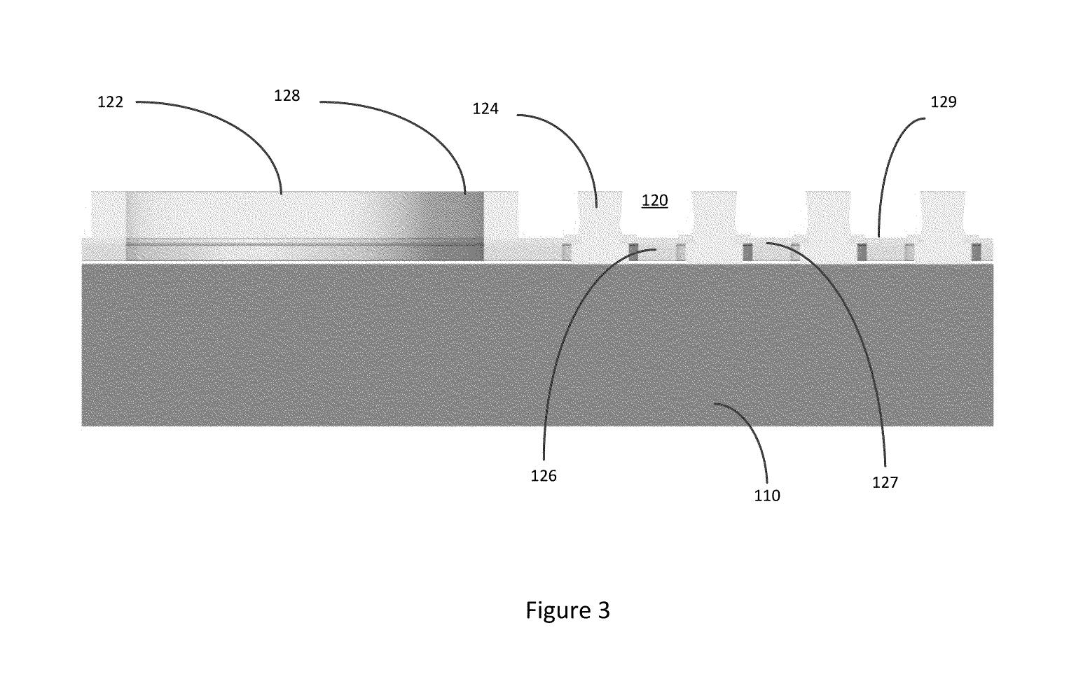

FIG. 3 illustrates a side view of a portion of a connector plug according to an embodiment of the present invention. As before, plug 120 may reside on printed circuit board 110. Plug 120 may include a number of contacts 124, which may be electrically connected to pads or contacts on a top surface of printed circuit board 110. These pads or contacts may be connected to traces in or on printed circuit board 110. Connector plug 120 may include a stiffener layer 126 supporting contacts 124. An insulating layer 129 may be placed on a top surface of plug 120. This insulating layer may be polyimide or other material. An adhesive layer 127 may be used to join stiffener layer 126 to insulating layer 129.

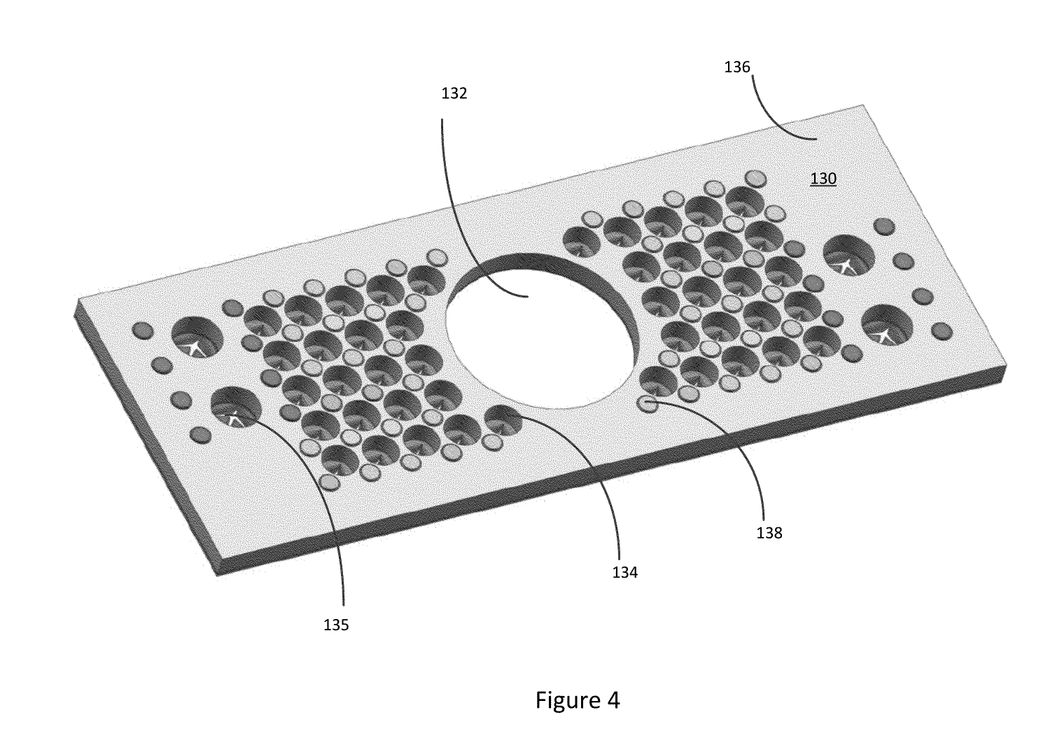

FIG. 4 illustrates a connector receptacle according to an embodiment of the present invention. Connector receptacle 130 may include a number of openings for contacts 134. Contacts 134 may electrically connect to contacts portions 138. Contact portions 138 may electrically connect contacts 134 to pads or contacts on an underside of a flexible circuit board or other appropriate substrate. Contacts 134 and contact portions 138 may be supported by receptacle stiffener layer 136. Receptacle 130 may include and larger contacts 135 for accepting larger power contacts 129 on a plug, such as connector plug 120. Receptacle 130 may include an opening 132 to accept alignment ring 128 on connector plug 120.

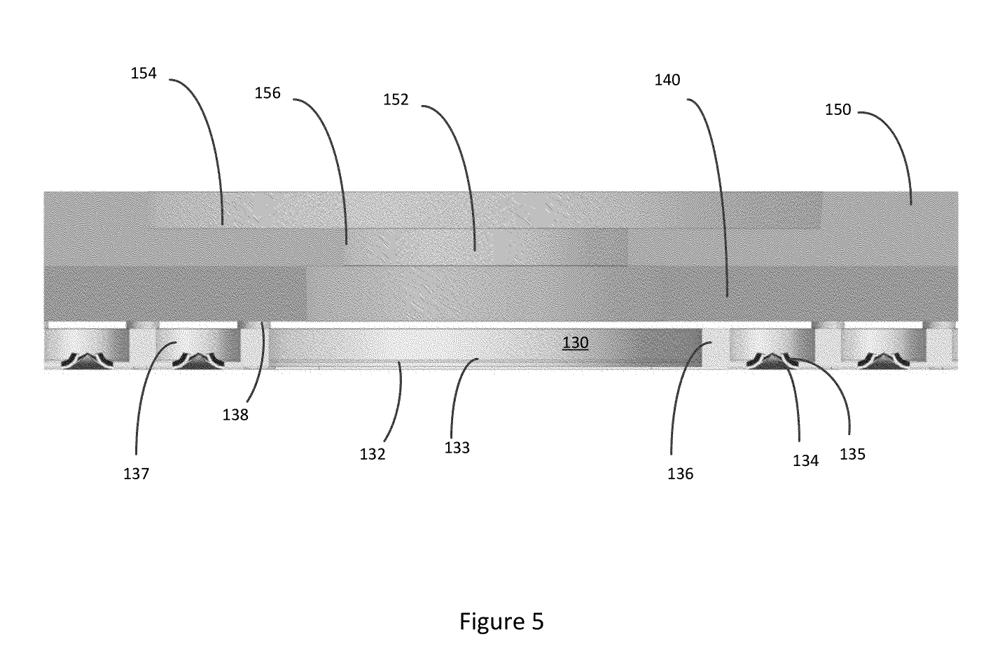

FIG. 5 illustrates a side view of a portion of a board-to-board connector system according to an embodiment of the present invention. In this example, receptacle 130 may be attached to a flexible circuit board 150. A stiffener layer 150 may be placed over flexible circuit board 140. Flex stiffener layer 150 may have an opening 152 and recess 154 for a fastener. Specifically, a body of the fastener may pass through opening 152 and a head of the fastener may be seated in recess 154. Opening 156 may include reinforcement 156 to protect flexible circuit board 150 from damage when a fastener is inserted into opening 156.

Connector receptacle 130 may include a stiffener layer 136 for supporting contacts 134. Contacts 134 may be isolated by insulation layer 135, which may be polyimide or other material. An adhesive layer 133 may be used to join receptacles stiffener layer 136 and insulating layer 135. Contacts 134 may electrically connect to contact portions 138. Contact portions 138 may electrically connect to pads or contacts on and other side of flexible circuit it board 140.

In various embodiments of the present invention, flex stiffener 150 may be formed of stainless steel or other conductive material. In these cases, an extra insulating layer may be placed between the flexible circuit board 140 and flex stiffener 150 in order to reduce coupling capacitances between connector receptacle and plug contacts. This insulating layer may be formed of polyimide or other material.

When a connector plug, such as connector plug 120, is mated with receptacle 130, plug contacts 124 may be inserted into openings 137 in receptacle stiffener layer 130. Plug contacts 124 may electrically connect to contacts 134. To facilitate this contact, an opening between portions of contacts 134 may be made narrower than openings in insulating layer 135. In this way, insulating layer 135 may flex either less or not at all, and long-term reliability of receptacle 130 may be increased.

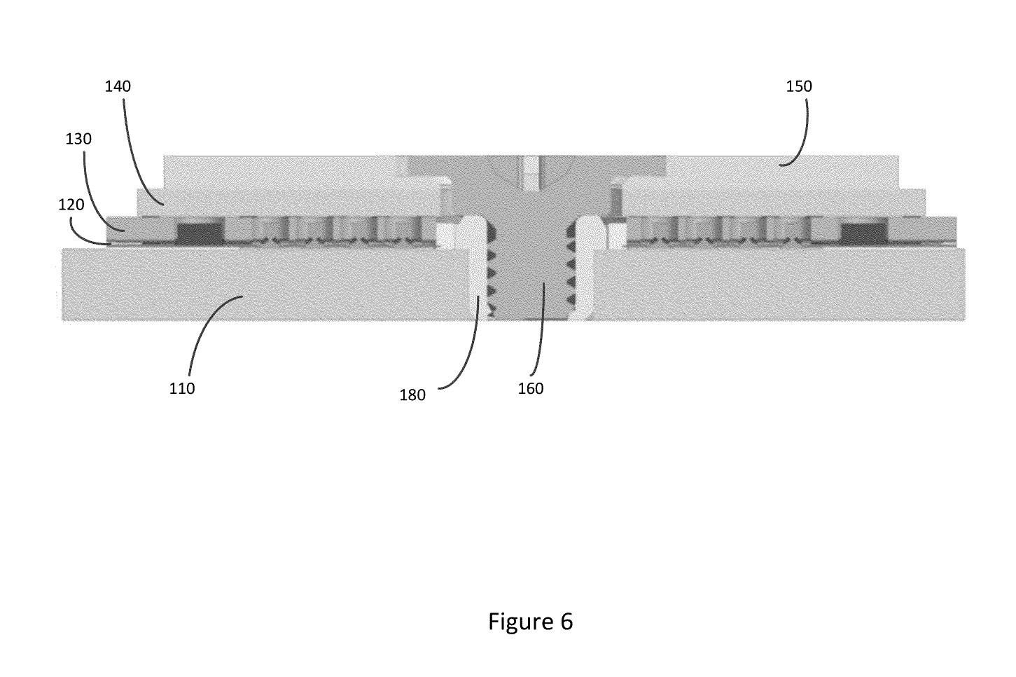

FIG. 6 illustrates a side view of a board-to-board connector according to an embodiment of the present invention. In this example, traces in flexible circuit board 140 may be electrically connected to traces in printed circuit board 110 through receptacle 130 and plug 120. A stiffener layer 150 may be used to improve the structural integrity of flexible circuit board 140. A fastener, such as screw 160, may be inserted into nut 180 to secure these structures together.

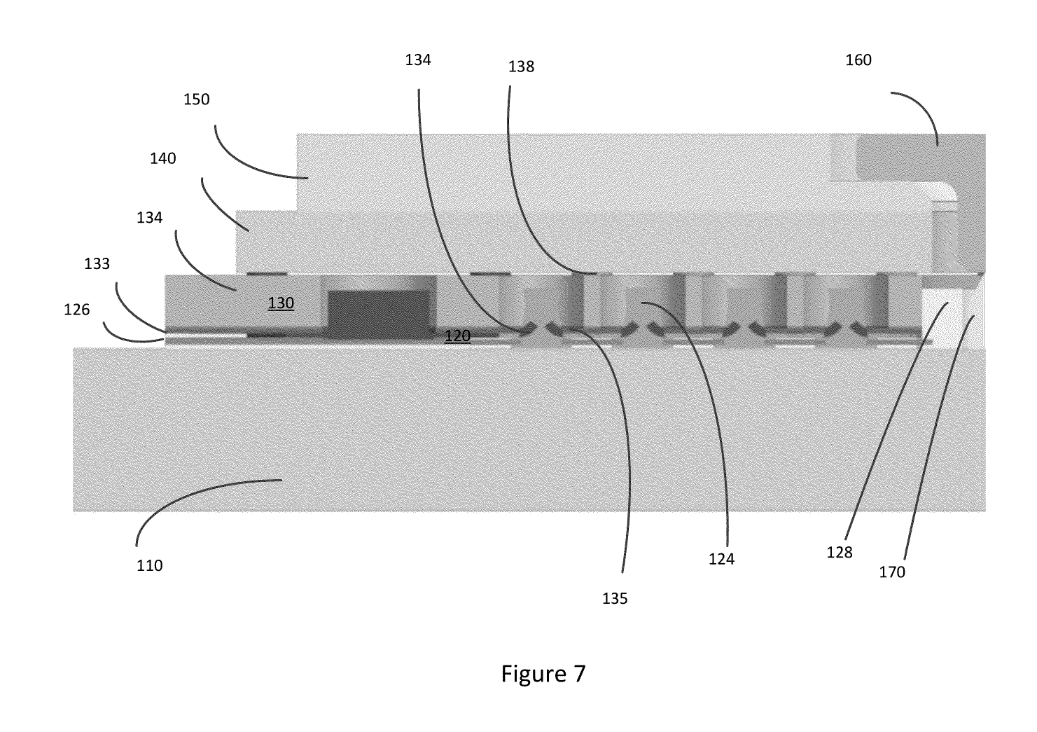

FIG. 7 illustrates a closer side view of a board-to-board connector system according to an embodiment of the present invention. This figure may include a printed circuit board or other appropriate substrate 110. Plug 120 may be mounted on a top surface of printed circuit board 110. Plug 120 may include a number of contacts 124. Contacts 124 may be electrically connected to contacts or pads on a top surface of printed circuit board 110. Contacts 124 may mate with contacts 134 on receptacle 130. Contacts 134 may electrically connect to contact portions 138 on receptacle 130. Contact portions 138 may electrically connect to pads or contacts on a bottom side of flexible circuit board 140. As before, stiffener layer 150 may be used to provide mechanical support for flexible circuit layer 140.

Contacts 124 on connector plug 120 may be mechanically supported by stiffener layer 126. Alignment ring 128 may be formed on plug 120. Fasteners 160 may mate with nut 170 to secure the connector together as a unit.

In various embodiments of the present invention, connector systems may be joined together in various ways. For example, screws and nuts may be used to join a plug to a receptacle and secure them in place relative to each other. In various embodiments of the present invention, the nuts may be inserted from a bottom of a printed circuit board or other appropriate substrate, as shown in FIG. 1. In other embodiments of the present invention, they may be placed in the top of an opening in a printed circuit board or other appropriate substrate, as shown in FIG. 6. An example is shown in the following figure.

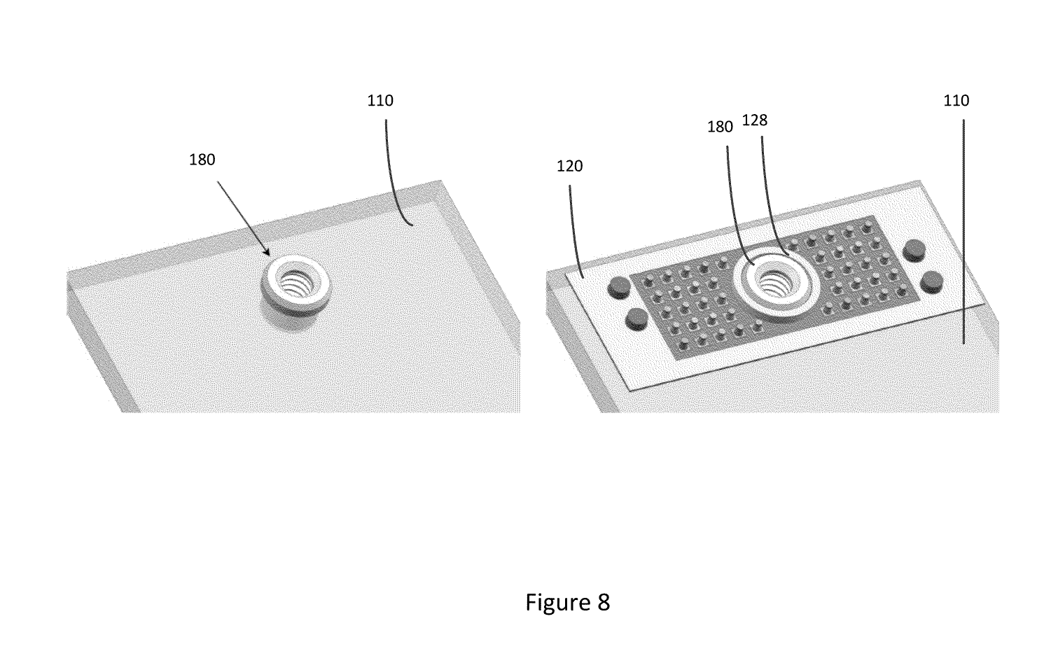

FIG. 8 illustrates portions of a board-to-board connector system according to an embodiment of the present invention. In this figure, fastener 180 is inserted in to a top of an opening and printed circuit board 110. Plug 120 may include and alignment ring 128. Alignment ring 128 may be arranged to accept a top ridge on fastener 180.

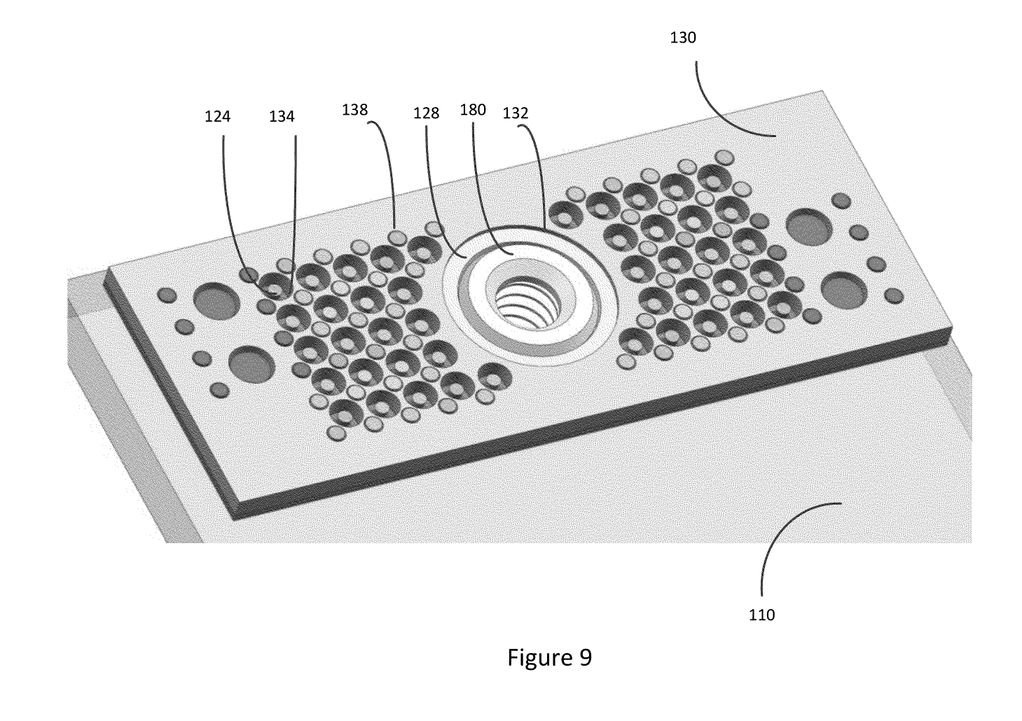

FIG. 9 illustrates portions of a board-to-board connector system according to an embodiment of the present invention. In this example, receptacle 130 has been mated with plug 120. Opening 132 may be set around alignment ring 128. Plug contacts 124 may be mated with receptacle contacts 134. Contact portions 138 may be available on a top surface of receptacle 130 to mate with contacts or pads on an underside of a flexible circuit board or other appropriate substrate.

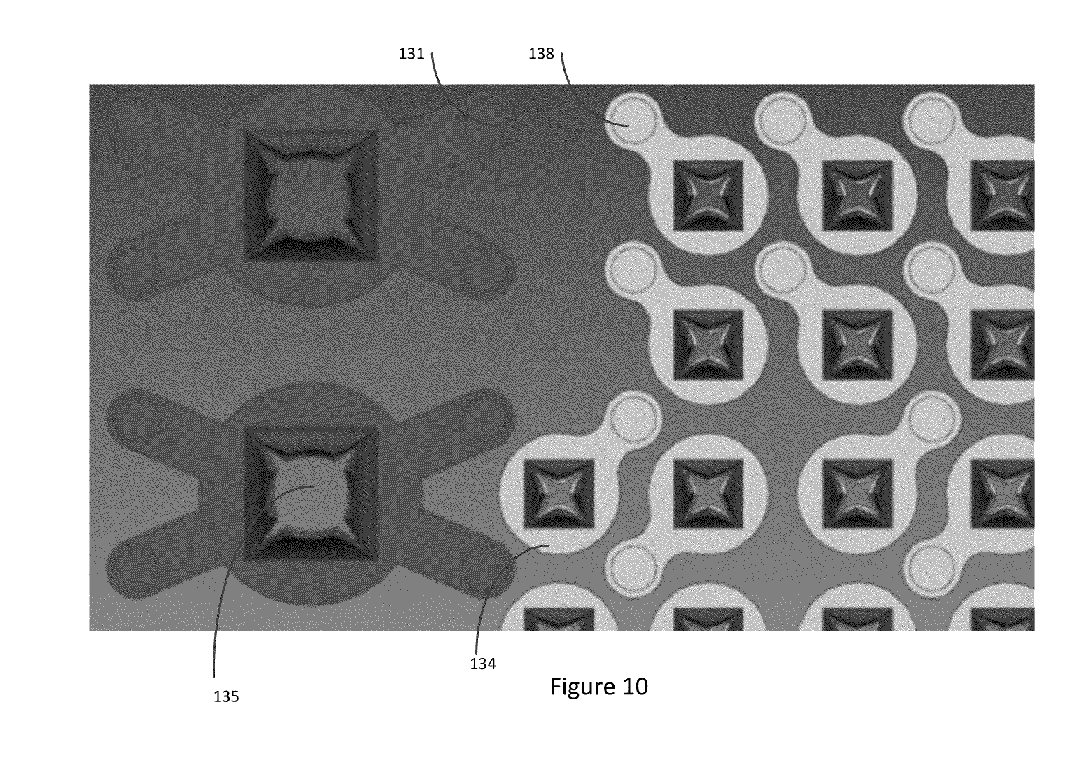

FIG. 10 illustrates a portion of a connector receptacle according to an embodiment of the present invention. In various embodiments of the present invention, connector receptacle contacts may have various shapes and may have interconnect lines that are routed in different ways. In this example, a portion of a connector receptacle may include a number of contacts 134. Contacts 134 may electrically connect to contact portions 138. Contact portions 138 may extend to an opposing side of the receptacle where they may mate with contacts or pads on a flexible circuit board or other appropriate substrate. The routing between contacts 134 and contact portions 138 may be uniform or it may follow alternating patterns as shown. In other embodiments the present invention, these interconnects may form still further patterns. Also, while contacts 134 may electrically connect to one contact portion 138, in other embodiments of the present invention, other contacts, such as power contacts 135, may electrically connect to multiple contacting portions 131. For example, power contact 135 may mate with four contact portions 131 for reduced resistance and increased current carrying capability. In other embodiments of the present invention, receptacle contacts may mate with two, three, five, six, or more than six contact portions. Also, while openings to contacts 134 are shown as having four sections, these openings may be formed to have other shapes in other embodiments of the present invention. In these and other embodiments of the present invention, the contact points need not be symmetrical. For example, they may not be radial to the center of the contact but instead may be angled like traditional bicycle wheel spokes. These contacts may be longer and may provide more deflection margin.

Embodiments of the present invention are particularly well-suited to connecting flexible circuit boards to printed circuit boards, though embodiments of the present invention may be used to connect two or more boards together, where the two or more boards include flexible circuit boards, printed circuit boards, or other appropriate boards. For example, embodiments of the present invention may be used to connect two flexible circuit boards, two printed circuit boards, two flexible circuit boards and one printed circuit board, or other combination of boards.

An illustrative embodiment of the present invention may provide board-to-board connectors where contacts in a plug form electrical connections with traces or planes in or on a first or printed circuit board. Similarly, contacts in a receptacle may form electrical connections with traces or planes in or on a second or flexible circuit board. Contacts in the plug may mate with contacts in the receptacle. In this way, traces and planes on a first or printed circuit board may be electrically connected to traces and planes on a second or flexible circuit board. These various connections may convey power supplies, ground, data, and other types of voltages and signals.

In various embodiments of the present invention, plug and receptacle contacts may be formed by stamping, metal-injection molding, machining, micro-machining, 3-D printing, or other manufacturing process. The plug and receptacle contacts and other conductive portions may be formed of stainless steel, steel, copper, copper titanium, phosphor bronze, or other material or combination of materials. They may be plated or coated with nickel, gold, or other material. The flex, plug, and receptacle stiffeners may be formed of silicon or silicone, rubber, hard rubber, plastic, nylon, liquid-crystal polymers (LCPs), or other conductive or nonconductive material or combination of materials. One or more of the flex, plug, and receptacle stiffener layers may be formed of Basalt, S-2 glass (around 90 GPa), S-3 UHM glass (99 GPa), quartz or astroquartz, aramid (commercially sold as Kevlar 49 or Twaron, ceramic (3M Nextel 312, 440, 550, 610, 72, having tensile modulus 150, 190, 193, 380, 260, respectively, Zylon (180), Zylon HM (270), or PE (commercially sold as Spectra or Dyneema) stainless steel, or other material. In these and other embodiments of the present invention, one or more of the flex, plug, and receptacle stiffener layers may be formed of carbon fiber, a composite laminate structure, or other material or structure.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A board-to-board connector comprising:
a connector plug comprising:
a plurality of plug contacts;
a stiffener layer to secure the plurality of plug contacts together; and
an alignment ring surrounding an opening in the connector plug, wherein the plug contacts and the alignment ring extend beyond a surface of the stiffener layer; and
a connector receptacle comprising:
a stiffener layer having a plurality of passages; and
a plurality of receptacle contacts, each partially covering a bottom of an opening of a passage in the stiffener layer and further comprising a contact portion at a top of the stiffener layer, wherein each of the plurality of plug contacts is inserted in a passage in the receptacle such that it electrically connects to a corresponding receptacle contact and wherein the alignment ring is fit in an opening in the connector receptacle.

2. The board-to-board connector of claim 1 wherein the connector plug further comprises an insulating layer over the stiffener layer.

3. The board-to-board connector of claim 2 wherein the connector plug insulating layer is polyimide.

4. The board-to-board connector of claim 3 wherein the connector plug insulating layer is fixed to the plug stiffener layer with an adhesive.

5. The board-to-board connector of claim 1 wherein the plurality of plug contacts each have a diameter of approximately 0.2 millimeters.

6. The board-to-board connector of claim 1 wherein the connector plug further comprises a plurality of power contacts, the power contacts wider than the plurality of plug contacts.

7. The board-to-board connector of claim 1 wherein the plurality of contacts and the alignment ring are formed together by plating.

8. The board-to-board connector of claim 1 wherein the connector receptacle further comprises an insulating layer under the stiffener layer.

9. The board-to-board connector of claim 8 wherein the connector receptacle insulating layer is polyimide.

10. The board-to-board connector of claim 9 wherein the connector receptacle insulating layer is fixed to the receptacle stiffener layer with an adhesive.

11. The board-to-board connector of claim 1 wherein the connector receptacle further comprises a plurality of power contacts, the power contacts electrically connected to a plurality of contact portions at a top of the stiffener layer.

12. The board-to-board connector of claim 1 wherein the connector receptacle contacts are routed to corresponding contact portions, wherein the direction of routing is flipped for each receptacle contact in a row of receptacle contacts.

13. The board-to-board connector of claim 1 wherein the connector plug and the connector receptacle are held together by a first fastener fixed to a second fastener.

14. A method of assembling a board-to-board connector, the method comprising:
attaching a connector plug to a printed circuit board, the connector plug comprising a plurality of contacts fixed together by a plug stiffener layer, each electrically connected to a contact on a top surface of the printed circuit board and extending above the plug stiffener layer, the connector plug further comprising an opening, the opening surrounded by an alignment ring;
attaching a connector receptacle to a flexible circuit board, the connector receptacle comprising a plurality of contacts fixed together by a receptacle stiffener layer having a corresponding plurality of passages, each contact electrically connected to a contact on a bottom surface of the flexible circuit board, each contact at least partially covering a bottom of a passage;
mating the connector plug to the connector receptacle such that the alignment ring on the connector plug fits in an opening in the connector receptacle and each of the connector plug contacts is inserted in a corresponding passage in the connector receptacle such that it is electrically connected to a receptacle contact;
fitting a first fastener to the printed circuit board; and
inserting a second fastener through an opening in the flexible circuit board, the opening in the connector receptacle, and the opening in the connector plug such that it engages the first fastener.

15. The method of claim 14 wherein fitting the first fastener to the printed circuit board comprises:
placing a body of the fastener into an opening in the printed circuit board from a bottom of the printed circuit board such that a head of the printed circuit board fits in a recess in the bottom of the printed circuit board.

16. The method of claim 14 wherein fitting the first fastener to the printed circuit board comprises:
placing a body of the fastener into an opening in the printed circuit board from a top of the printed circuit board such that a head of the printed circuit board rests on a top of the printed circuit board.

17. The method of claim 14 wherein engaging the first fastener and the second fastener comprises screwing the first fastener into the second fastener.

18. The method of claim 17 wherein the first fastener is a screw and the second fastener is a nut.

19. The method of claim 14 further comprising:
forming a stiffener layer over the flexible circuit board.

20. The method of claim 19 wherein the stiffener layer over the flexible circuit board comprises an opening, wherein the second fastener is also inserted through the opening in the stiffener layer for the flexible circuit board.
